(19) United States
(12) Patent Application Publication
(10) Pub. No.: US 2004/0183243 A1
(43) Pub. Date: Sep. 23, 2004

(54) Spring enhancer

(76) Inventors: Yen-Ming Chen, Taiping City (TW); Te-Chung Chen, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 10/756,279

(22) Filed: Jan. 14, 2004

(30) Foreign Application Priority Data
Mar. 20, 2003 (TW) 092204666

(51) Int. Cl. F16F 1/04

(52) U.S. Cl. 267/286

(57) ABSTRACT

A spring enhancer comprising a body installed between the space of the springs; the present invention is an extra device without changing any original structure and is directly installed onto the original springs, such scheme is simple in structure and easy to install, not only solve the tedious and high cost to re-equip the shock absorbers of automobiles and also improve the over-leaning condition due to the deformation of springs.

### BACKGROUND OF THE INVENTION

I. Field of the Invention

This invention relates generally to a spring enhancer and, more specifically, to a spring enhancer that installs in the space of a spring, especially for the springs of shock absorbers of automobiles or any spring, such as beds, elevators, mechanical equipments. The present invention can reduce the deformation when the springs are compressed, such effect can increase the coefficient and loading of the springs, and improve the over-leaning condition when automobiles make turn due to springs deformation.

II. Description of the Prior Art

Heretofore, it is known that most of the spring applications such as: beds, elevators, and mechanical field under long-term heavy impact will cause deformation, lose original spring function; especially, the shock absorbs applied in automobiles, the springs absorb vibration by deformation while automobiles are moving, therefore in the spring technology field, the shock absorbers not only have to endure heavy impact but also reduce the deformation under heavy impact, most of all, not to cause over-leaning when the automobiles make turn by the deformation of springs.

Some drivers might re-equip their shock absorbers to improve the over-leaning condition, the most common way is to replace the springs with less deformation types; the re-equipment is very costly, the original shock absorbers must be dismantled completely for new springs, that is very tedious and expensive, the replaced springs will be obsolete and waste.

### SUMMARY OF THE INVENTION

It is therefore a primary object of the invention to provide a spring enhancer to increase the hardness and reduce the deformation of the springs.

In order to achieve the objective set forth, a spring enhancer in accordance with the present invention comprises a body installed between the space of the springs; the present invention is an extra device without changing any original structure and is directly installed onto the original springs, such scheme is simple in structure and easy to install, not only solve the tedious and high cost to re-equip the shock absorbers of automobiles and also improve the over-leaning condition due to the deformation of springs.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the present invention;

FIG. 2 is a cross-sectional view of the present invention;

FIG. 3 is a cross-sectional view of the first application according to the present invention;

FIG. 4 is a cross-sectional view of the embodiment of the present invention;

FIG. 5 is a cross-sectional view of another application according to the present invention;

FIG. 6 is a cross-sectional view of further embodiment according to FIG. 5;

FIG. 7 is a cross-sectional view of another application according to the present invention;

FIG. 8 is a cross-sectional view of further embodiment according to FIG. 7;

FIG. 9 is a cross-sectional view of another application according to the present invention;

FIG. 10 is a cross-sectional view of further embodiment according to FIG. 9;

FIG. 11 is another assembly view of the present invention;

FIG. 12 is another assembly view of the further embodiment according to the present invention;

FIG. 13 is a cross-sectional view of another application according to the present invention;

FIG. 14 is a cross-sectional view of another application according to the present invention;

FIG. 15 is another assembly view of the present invention;

FIG. 16 is another assembly view of the present invention;

FIG. 17 is a perspective view of another application according to the present invention;

FIG. 18 is an assembly view of another application of FIG. 17;

FIG. 19 is an assembly view of a further embodiment according to the present invention;

FIG. 20 is an assembly view of a further embodiment of FIG. 19;

FIG. 21 is an assembly view of a further embodiment according to the present invention;

FIG. 22 is a cross-sectional view of a further embodiment of FIG. 21;

FIG. 23 is a cross-sectional view of another application according to the present invention;

FIG. 24 is a cross-sectional view of a further embodiment of FIG. 23;

FIG. 25 is a cross-sectional view of another application according to the present invention;

FIG. 26 is a cross-sectional view of a further embodiment of FIG. 25;

FIG. 27 is an assembly view of a further embodiment according to the present invention;

FIG. 28 is a cross-sectional view of the embodiment according to FIG. 27;

FIG. 29 is a cross-sectional view of another application according to the present invention.

### DESCRIPTION OF THE PREFERRED EMBODIMENT

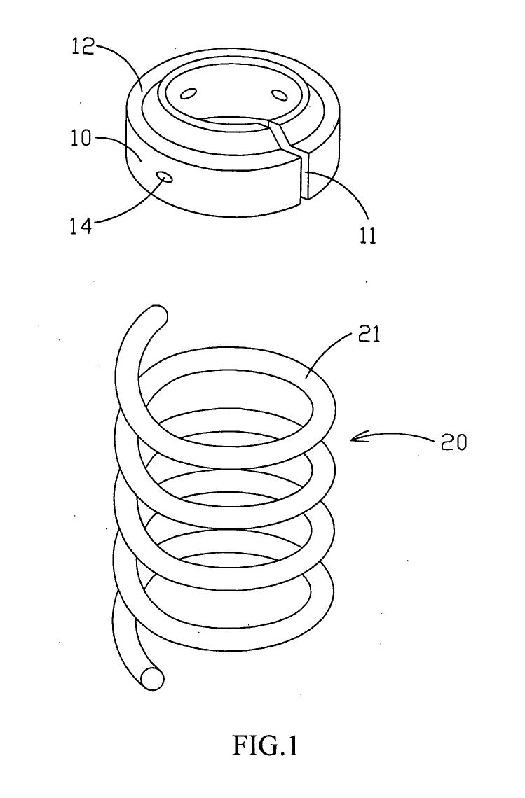

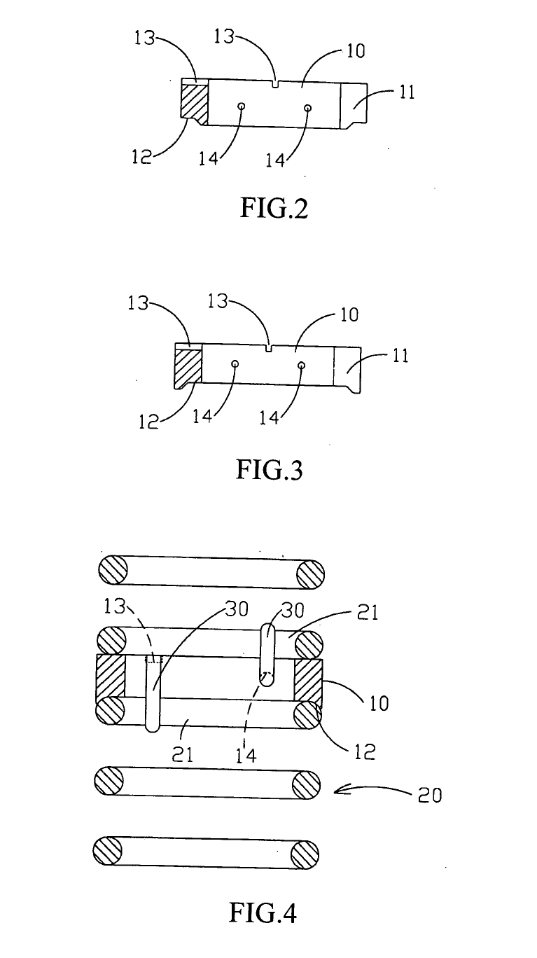

Referring to FIG. 1, the present invention is a body 10 stuffed between the space of a spring 20, the body 10 is in ring shape with a gap 11, the body 10 can be overlapped (as shown in FIG. 16) on both ends of the gap 11, an indentation ring 12 is on the body 10 for the spring ring 21 of the spring 20 to place, the indentation ring 12 can be on the top outer circumference as shown in FIG. 1 and FIG. 2, or on the top inner circumference as shown in FIG. 3.

Referring to FIG. 3 and FIG. 4, the contact position of the body 10 and the spring 20 not only has the indentation ring 12 for the spring ring 21, at least one ditch 13 is on the top of the body 10, the ditch 13 radiate out from the center of the body 10; at least one through hole 14 is on the body 10, the through hole 14 also radiate out from the center of the body 10; many fastener 30 made of ribbon span the ditch 13 and pass through the through hole 14 to fasten the body 10 onto the spring ring 21 of the spring 20, the body 10 is installed easily on the space of the spring 20.

The present invention can be applied on the original springs of the shock absorbers without changing the original equipments of the automobiles; such enhancement offers extra supporting effect on the spring with present invention for an auxiliary support to reduce the deformation during compression and increase the coefficient of the spring, the loading of the springs can increase and effectively improve the over-leaning condition due to the deformation while the automobiles is turning; the present invention can also apply to any equipment with springs, such as spring beds, elevators, mechanical equipments . . . to increase the hardness of the springs and reduce the deformation.

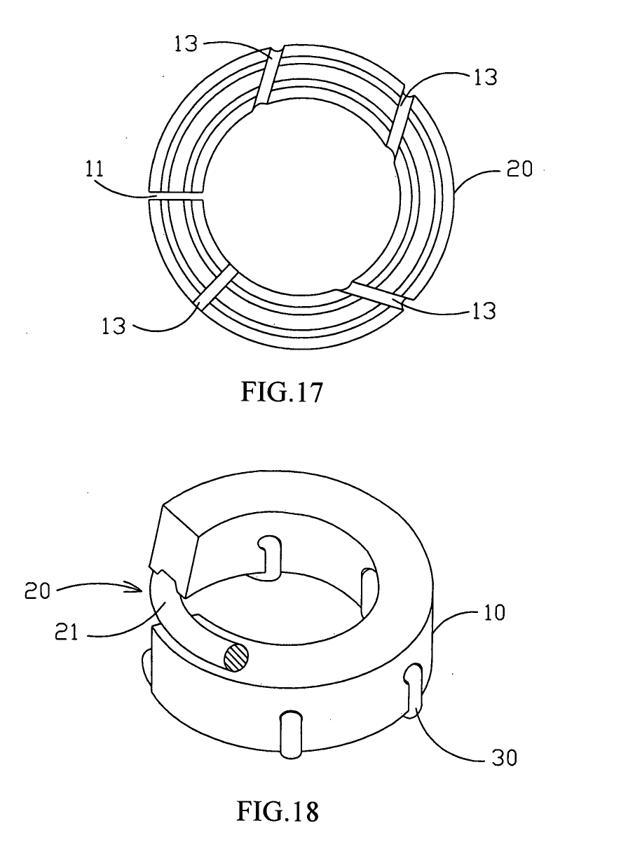

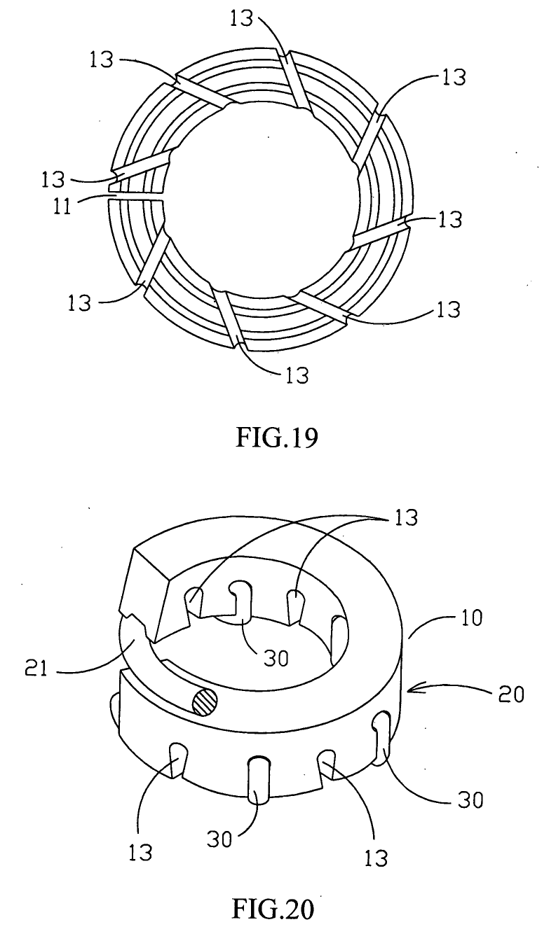

Referring to FIG. 17 and FIG. 18, the ditch 13 for the fastener 30 can slant certain angle along the direction of the spring 20, or the stretching direction of the ditch 13 can pass the center of the spring 20, the spring 20 can have a binding effect along the compression direction when it is compressed for better fastening effect; as shown in FIG. 19 and FIG. 20, the ditch 13 can be in multiple numbers for the fastener 30 to have multiple location choices.

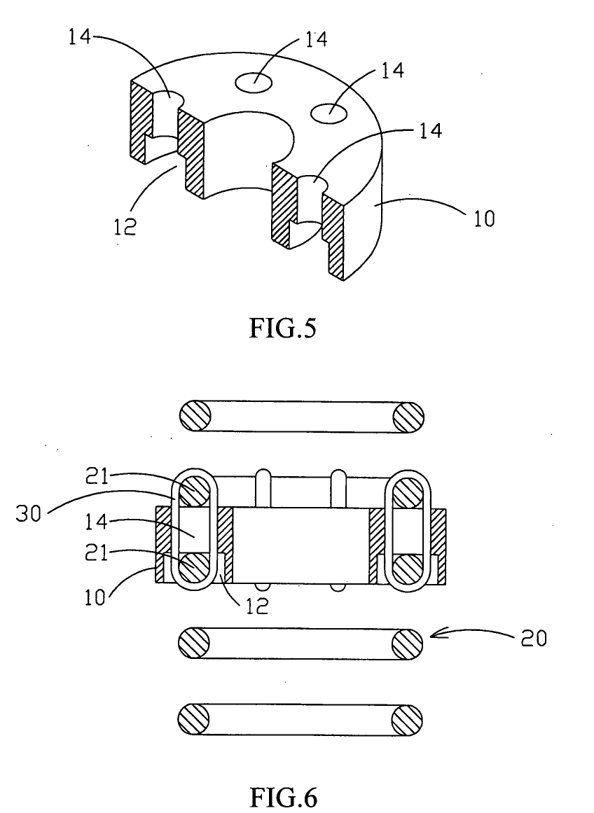

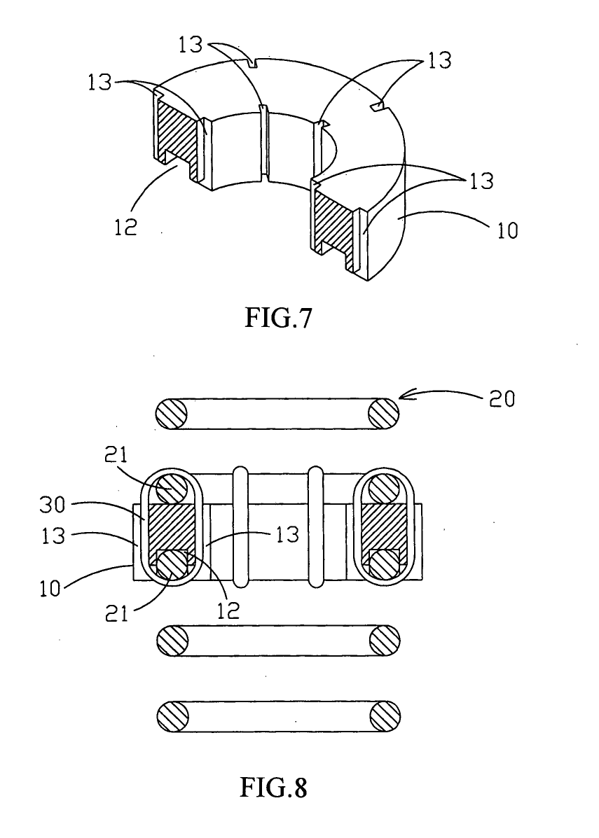

Referring to FIG. 5 and FIG. 6, the indentation ring 12 to stable the spring ring 21 can also locate on the top center of the body 10, and at least one through hole 14 on the other spring level is on the body 10 for fastener 30 to pass through and fasten the body 10 and the spring ring 21; or as shown in FIG. 7 and FIG. 8, several corresponding ditch 13 are on inner and outer ring of the body 10, the fastener 30 span over those ditch 13 to fasten the body 10 and the spring ring 21.

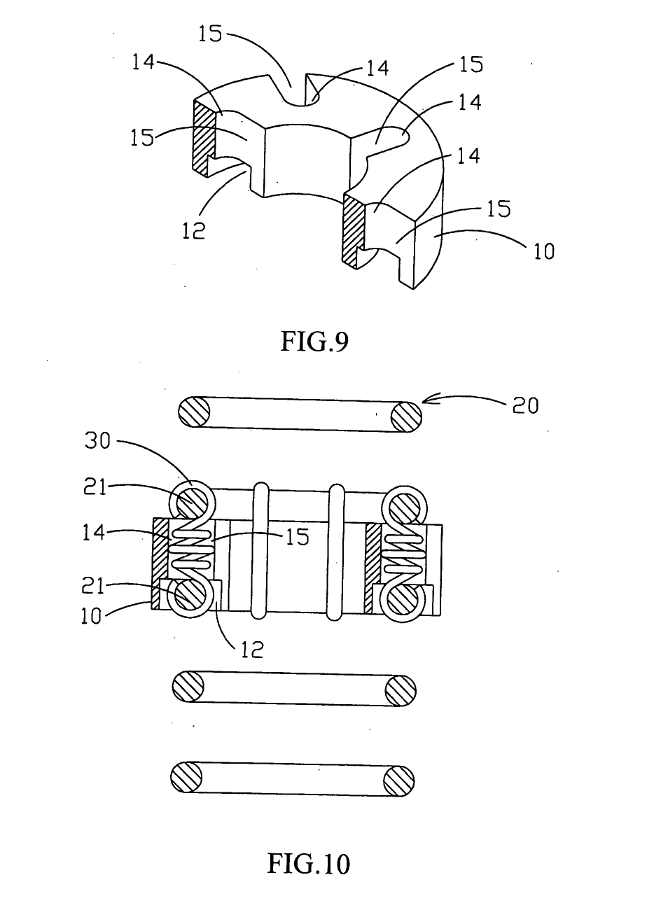

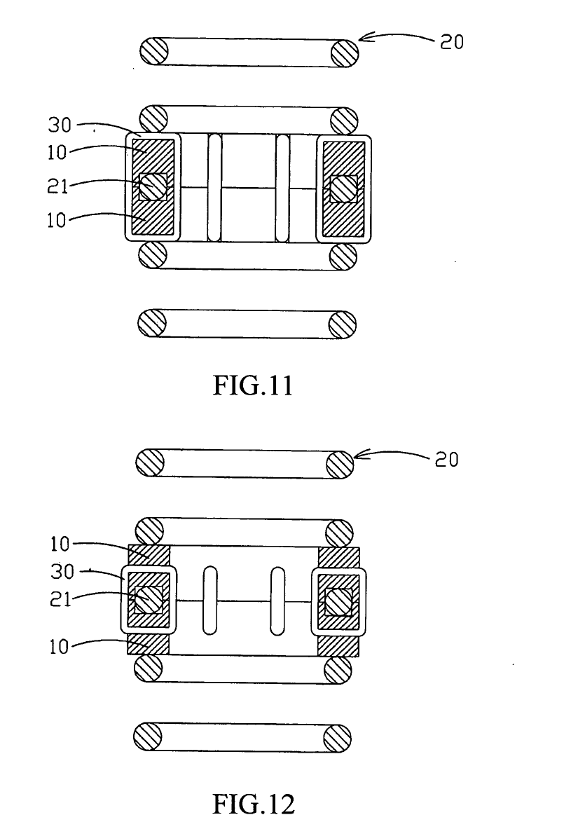

Referring to FIG. 9 and FIG. 10, the through hole 14 passing 20 from the indentation ring 12 to other spring level has an open 15 toward the inner or outer ring of the body 10, the fastener 30 made of elastic spring can hook on the upper and lower level of spring ring 21 to fasten the body 10 and the spring ring 21 together.

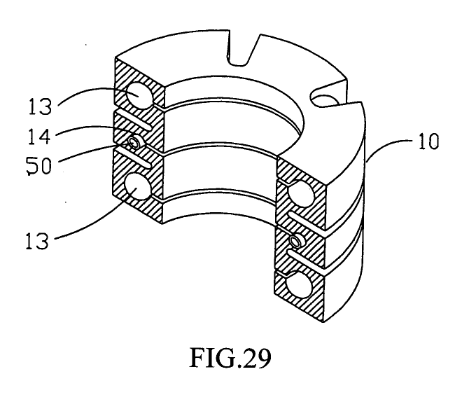

Referring to FIG. 11 and FIG. 12 that shows an application of the present invention, two body 10 are stacked up on the spring ring 21 of the spring 20, or as shown in FIG. 29, the whole body 10 is made into a flexible ring structure with through hole 14, the spring 21 of the spring 20 can pass through the through hole 14 for stable linking effect, an elastic buffer 50 is inside the through hole 14, the elastic buffer 50 is in tube structure with fluid inside, the amount of fluid can adjust the buffer effect to the spring 20.

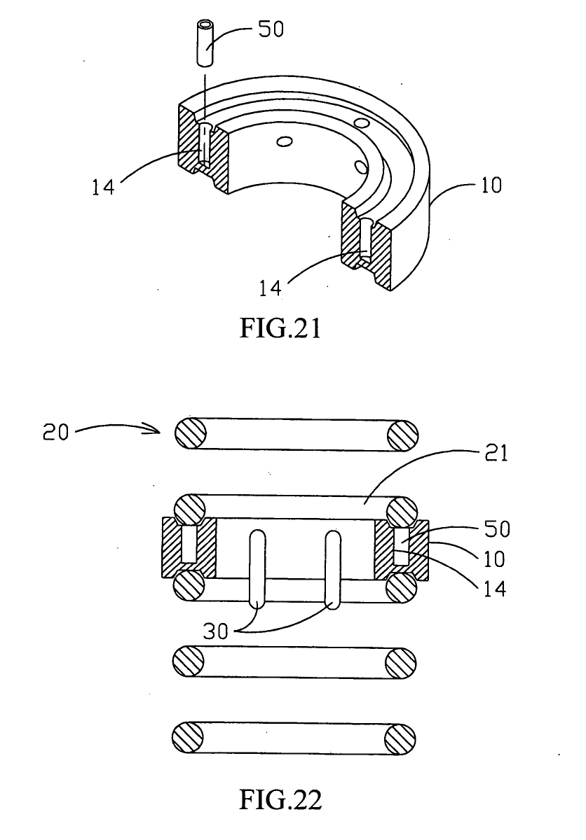

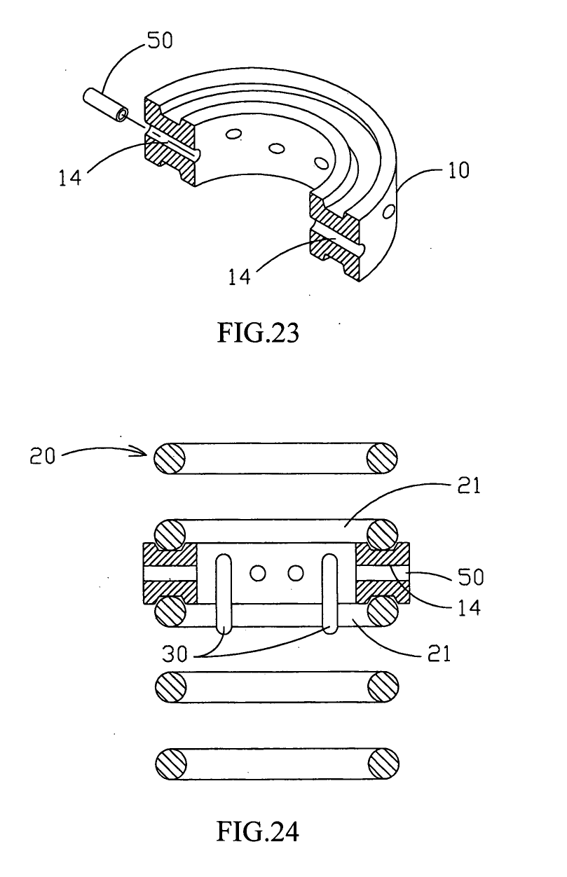

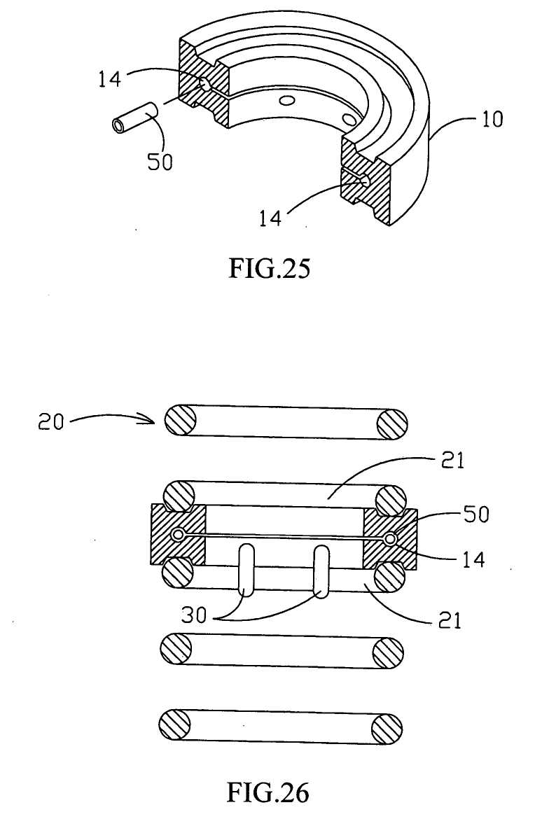

Referring to FIG. 21 and FIG. 22, at least one through hole 14 is vertically installed on the body 10, an elastic buffer 50 is inside the through hole 14, the elastic buffer 50 is a hollow tube or solid structure; different elastic buffer 50 with different materials can contribute different buffer effect, by changing the amount of liquid inside the hollow tube also can adjust the buffer effect on the spring 20. The through hole 14, as shown in FIG. 23 and FIG. 24, in installed horizontally in the body 10, or as shown in FIG. 25 and FIG. 26, the through hole 14 is installed around the body 10 for same effect.

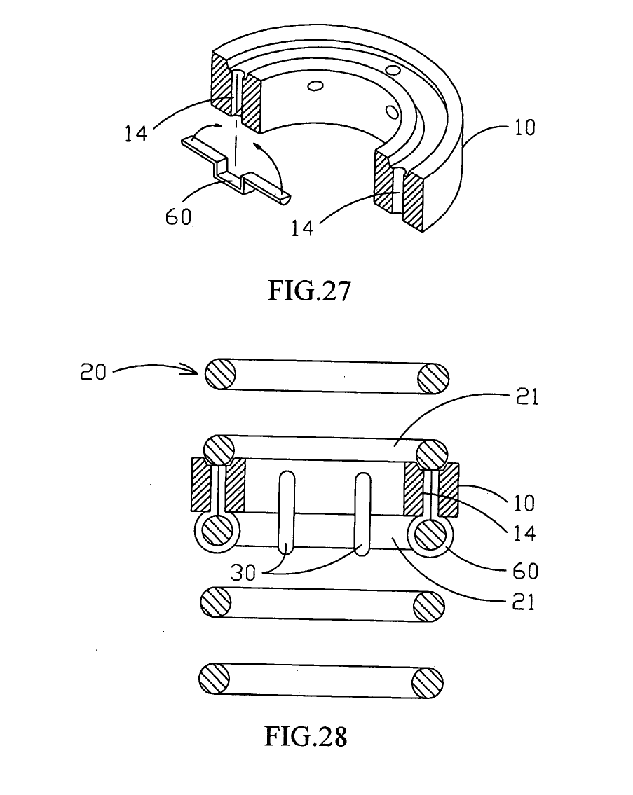

Referring to FIG. 27 and FIG. 28, at least one through hole 14 is on the body 10, a supporter 60 is inside the through hole 14; the supporter 60 is in clamp structure and stretches into the through hole 14, clips the spring ring 21 for supporting effect.

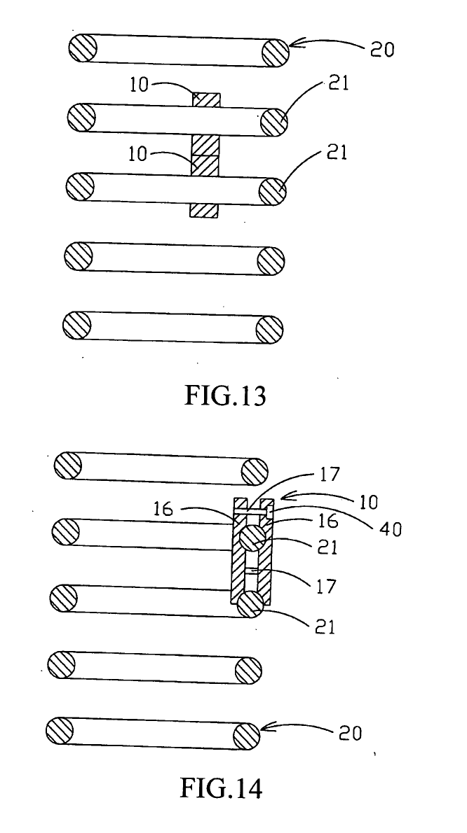

Referring to FIG. 13, the body 10 is in round shape for the spring ring 21 to pass through and wraps around the spring 20 directly; as shown in FIG. 14, the body 10 is fastened by the clip 16 and screw 40 on inner and outer ring of the spring ring 21.

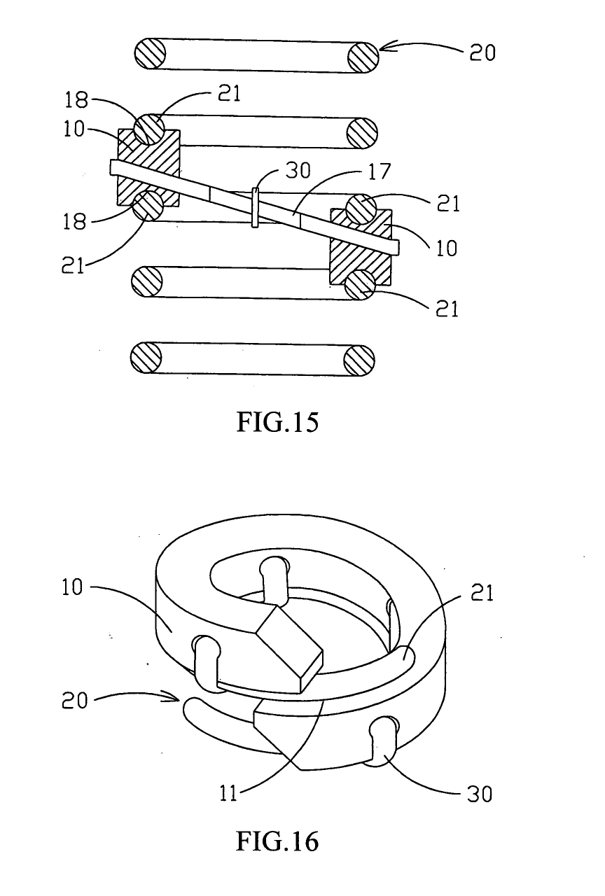

Referring to FIG. 15, two body 10 stuffed between the spring 20 are linked with a fixing arm 17, a concave 18 each for the spring ring 21 to place is on top and bottom of the body 10 to stable the spring 20 for less deformation of the spring 20.

While a preferred embodiment of the invention has been shown and described in detail, it will be readily understood and appreciated that numerous omissions, changes and additions may be made without departing from the spirit and scope of the invention.

What is claimed is:

1. A spring enhancer is a body stuffed between the space of a spring to generate an auxiliary support effect and reduce the deformation.

2. The spring enhancer recited in claim 1, wherein said body is made into a flexible ring structure with a gap.

3. The spring enhancer recited in claim 2, wherein the contact position of said body and the spring has an indentation ring for the spring ring, at least one ditch is on the top of said body, said ditches radiate out from the center of said body, many fasteners made of ribbon span the ditches to fasten said body onto the spring ring.

4. The spring enhancer recited in claim 2, wherein the contact position of said body and the spring has an indentation ring for the spring ring, at least one through hole is on said body, said through holes radiate out from the center of said body, many fasteners made of ribbon pass through said through holes to fasten said body onto the spring ring of the spring.

5. The spring enhancer recited in claim 2, wherein the contact position of said body and the spring has an indentation ring for the spring ring, at least one ditch is on the top of said body, said ditch radiate out from the center of said body, at least one through hole is on said body, the through holes radiate out from the center of said body; many fasteners made of ribbon span said ditches and pass through said through holes to fasten said body onto the spring ring of the spring.

6. The spring enhancer recited in claim 3, wherein said indentation ring locates on the top outer circumference of said body.

7. The spring enhancer recited in claim 3, wherein said indentation ring locates on the top inner circumference of said body.

8. The spring enhancer recited in claim 3, wherein said indentation ring locates on the top center of said body.

9. The spring enhancer recited in claim 2, wherein the contact position of said body and the spring has an indentation ring for the spring ring, at least one through hole is on said body, said through holes pass to other spring level, many fasteners made of ribbon span said ditches to fasten said body and the spring ring of spring.

10. The spring enhancer recited in claim 2, wherein the contact position of said body and the spring has an indentation ring for the spring ring, at least one through hole is on said body, said through holes pass to other spring level, many fasteners made of ribbon span said ditches to fasten said body and the spring ring of spring.

11. The spring enhancer recited in claim 2, wherein the contact position of said body and the spring has an indentation ring for the spring ring, at least one through hole is on said body, said through holes pass to other spring level, said through holes have an open toward the inner or outer ring of said body, several fasteners made of elastic spring hook on the upper and lower level of spring ring to fasten said body and the spring ring together.

12. The spring enhancer recited in claim 1, wherein said body is in round shape for spring ring to pass.

13. The spring enhancer recited in claim 1, wherein said body is fastened by clips and screws on inner and outer ring of the spring ring.

14. A spring enhancer compromising two body stuffed between the spring are linked with a fixing arm to generate an auxiliary support and reduce the deformation of spring.

15. The spring enhancer recited in claim 14, wherein a concave each for the spring ring to place is on top and bottom of said body.

16. The spring enhancer recited in claim 2, wherein said body overlaps on both ends of said gap.

17. The spring enhancer recited in claim 3, wherein said ditches slant certain angle along the direction of the spring.

18. The spring enhancer recited in claim 3, wherein the stretching directions of said ditches passes the center of the spring.

19. The spring enhancer recited in claim 3, wherein at least one through hole is vertically installed on said body, an elastic buffer is inside said through hole.

20. The spring enhancer recited in claim 3, wherein at least one through hole is horizontally installed on said body, an elastic buffer is inside said through hole.

21. The spring enhancer recited in claim 3, wherein at least one through hole is installed around said body, an elastic buffer is inside said through hole.

22. The spring enhancer recited in claim 3, wherein at least one through hole is on said body with a supporter inside.

23. The spring enhancer recited in claim 1, wherein said body is in round shape for the spring ring to pass through and wraps around the spring.

24. The spring enhancer recited in claim 1, wherein an elastic buffer passes through a through hole.

25. The spring enhancer recited in claim 19, 20, 21 or 24, wherein said elastic buffer is in tube structure.

26. The spring enhancer recited in claim 19, 20, 21 or 24 wherein said elastic buffer is solid.

27. The spring enhancer recited in claim 19, 20, 21 or 24 wherein said elastic buffer is in hollow tube structure with fluid inside.

28. The spring enhancer recited in claim 22, wherein said supporter is in clamp structure and stretches into the through hole, clips the spring ring.
